(19) United States
(12) Patent Application Publication
(10) Pub. No.: US 2021/0256444 A1
(43) Pub. Date: Aug. 19, 2021

(54) INFORMATION PROCESSING DEVICE, INFORMATION PROCESSING METHOD, AND INFORMATION PROCESSING PROGRAM

(71) Applicant: Nippon Telegraph and Telephone Corporation, Tokyo (JP)

(72) Inventors: Akira KOYAMA, Musashino-shi, Tokyo (JP); Yukiyoshi OTA, Musashino-shi, Tokyo (JP); Tomohiro KOKOGAWA, Musashino-shi, Tokyo (JP); Koji KISHI, Musashino-shi, Tokyo (JP); Naoko KOSAKA, Musashino-shi, Tokyo (JP)

(73) Assignee: Nippon Telegraph and Telephone Corporation, Tokyo (JP)

(21) Appl. No.: 16/973,772

(22) PCT Filed: Jun. 4, 2019
(86) PCT No.: PCT/JP2019/022196

§ 371 Date: Dec. 10, 2020

(30) Foreign Application Priority Data
Jun. 11, 2018 (JP) 2018-111181

(51) Int. Cl. G06Q 10/06; G06Q 50/26

(52) U.S. Cl. CPC G06Q 10/06315; G06Q 50/26; G06Q 10/063114

(57) ABSTRACT

An information processing device (20) includes a data analyzing unit (221) that acquires failure information of an infrastructure and recovery information of the infrastructure, analyzes the failure information of the infrastructure and recovery information of the infrastructure, and processes detailed information of the failure information of the infrastructure and recovery information of the infrastructure into simplified contents, and a concealed map display unit (222) that, in a case of receiving a request for the failure information and recovery information, outputs processed failure information and recovery information to a requester.

### TECHNICAL FIELD

The present invention relates to an information processing device, an information processing method, and an information processing program.

### BACKGROUND ART

In a case where an earthquake or the like occurs, and infrastructure-business corporations such as communication, electric power, and so forth experience failure at facilities of their corporations, these corporations swiftly comprehend the state of damage through monitoring systems. The state of damage that has been comprehended is notified to the public by a Web site or the like, following an investigation and internal memo.

The infrastructure-business corporations internally study plans regarding recovery of facilities, and decide an order of priority for recovery and so forth. Now, the order of priority for recovery and so forth is normally not made public from infrastructure-business corporations. Accordingly, the infrastructure-business corporations make recovery plans for their own corporations, without knowing the state of damage of other infrastructures in real time, recovery plans thereof, and so forth.

### CITATION LIST

### Patent Literature

[PTL 1] Japanese Patent No. 5787931

### SUMMARY OF THE INVENTION

### Technical Problem

However, the only way that infrastructure-business corporations can know the state of damage to other infrastructures is through Web sites, and cannot know the state of damage to other infrastructures in real time. There are cases where infrastructure-business corporations cannot effectively execute their own recovery plans because they do not know the recovery plans of other corporations. For example, it is difficult for a communication carrier to create a recovery plan for communication facilities in a state where recovery plans for electric power are unknown.

Accordingly, recovery information and damage information of important infrastructure businesses is information necessary to make recovery plans at other infrastructure businesses, and this information needs to be promptly shared among infrastructure-business corporations to smoothly create recovery plans. However, recovery information and so forth currently is secret information of corporations, and accordingly prompt sharing among businesses has not been realized.

The present invention has been made in light of the above, and it is an object thereof to provide an information processing device, information processing method, and information processing program, whereby cooperation regarding information can be suitably carried out among infrastructure businesses.

### Means for Solving the Problem

An information processing device according to the present invention includes an analyzing unit that analyzes failure information of an infrastructure and recovery information of the infrastructure, and processes detailed information of the failure information and recovery information into simplified contents, and an output unit that, in a case of receiving a request for the failure information and recovery information, outputs the processed failure information and recovery information to a requester.

### Effects of the Invention

According to the present invention, cooperation regarding information can be suitably carried out among infrastructure businesses.

### BRIEF DESCRIPTION OF DRAWINGS

FIG. 1 is a diagram illustrating an example of a configuration of an information sharing system according to an embodiment.

FIG. 2 is a diagram for describing a flow of processing by an information processing device illustrated in FIG. 1.

FIG. 3 is a diagram for describing a flow of processing by the information processing device illustrated in FIG. 1.

FIG. 4 is a sequence diagram illustrating processing procedures of information providing processing according to the embodiment.

FIG. 5 is a diagram illustrating an example of a computer where the information processing device is realized by a program being executed.

### DESCRIPTION OF EMBODIMENTS

An embodiment of an information processing device, an information processing method, and an information processing program according to the present application will be described below in detail, with reference to the Figures. Note that the present invention is not limited by this embodiment. Description will be made regarding an example of a case where the information processing device according to the present invention is realized as a device included in an information sharing system that enables infrastructure businesses to share failure information and recovery information of infrastructures in the event of damage occurring due to a disaster or the like, or as a function of the information sharing system.

### Embodiment

### [Overview of Affected Area Identifying System]

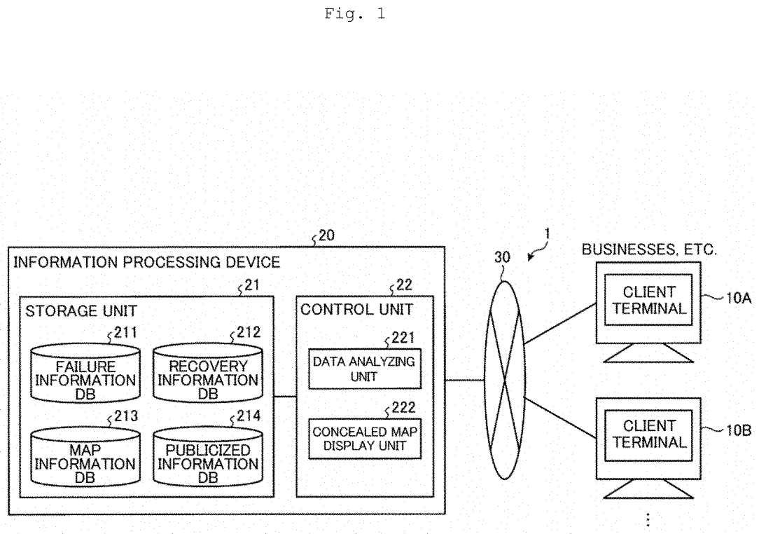

First, the configuration of the information sharing system according to the embodiment will be described with reference to FIG. 1. FIG. 1 is a diagram illustrating an example of the configuration of the information sharing system according to the embodiment.

The information sharing system 1 has a configuration where an information processing device 20 and client terminals 10A and 10B are connected via a network 30, as illustrated in FIG. 1. Note that the number of the client terminals 10A and 10B illustrated in FIG. 1 is only an example. When making description without distinguishing between the client terminals 10A and 10B, this will be written simply as client terminal 10.

The information sharing system 1 is a system which provides, in a case of a disaster striking such as an earthquake, large-scale flooding, or the like, failure information and recovery information of the infrastructures to the infrastructure businesses, government institutions, municipalities, and so forth. In other words, the information sharing system 1 is a system that enables the infrastructure businesses to share failure information and recovery information of the infrastructures. Examples of infrastructures include communication, electric power, gas companies, waterworks, roads, railways, airlines, banks, petrochemical plants, and so forth.

The information processing device 20 is a server device, for example. The information processing device 20 analyzes failure information of infrastructures and recovery information of infrastructures, processes detailed information of the failure information and recovery information into simplified contents, and provides the processed information to infrastructure businesses, government institutions, municipalities, and so forth. For example, the information processing device 20 provides failure map information, where post-processing failure information of infrastructures has been superimposed on map information, to client terminals 10 of government institutions, municipalities, and so forth. The information processing device 20 also provides recovery map information, where post-processing recovery information of infrastructures has been superimposed on map information, to client terminals 10 of government institutions, municipalities, and so forth.

The client terminals 10 are provided in the infrastructure businesses, government institutions, municipalities, and so forth. Examples of client terminals 10 include server devices, personal computers, and so forth. The client terminals 10 are provided with the failure map information and recovery map information from the information processing device 20. The infrastructure businesses, government institutions, municipalities, and so forth reference the map information relating to failure or recovery shown on the client terminal 10 to create recovery plans.

The network 30 may be any type of network, such as for example, a wired or wireless LAN (Local Area Network), WAN (Wide Area Network), VPN (Virtual Private Network), or the like.

[Configuration of Information Processing Device]

Next, the configuration of the information processing device 20 will be described. The information processing device 20 has a storage unit 21 and a control unit 22, as illustrated in FIG. 1.

The storage unit 21 is realized by a semiconductor memory element such as RAM (Random Access Memory), flash memory (Flash Memory), or the like, or a storage device such as a hard disk, optical disc, or the like, and stores processing programs to operate the information processing device 20, data used when running the processing programs, and so forth. The storage unit 21 has a failure information database (DB) 211, a recovery information DB 212, a map information DB 213, and a publicized information DB 214.

The failure information DB 211 stores failure information of the infrastructure businesses, received from the infrastructure businesses. Failure information is information received from monitoring centers of infrastructure businesses, and includes at least identification information of a facility where a failure has occurred, and position information thereof, in a correlated manner. For example, failure information is information received from a monitoring center of a communication carrier, and includes identification information of a communication station, base station, or the like, where a failure has occurred, and position information thereof, in a correlated manner. Also, failure information is information received from a monitoring center of an electric power company, and includes at least identification information of an electric power substation, utility pole, or the like, where a failure has occurred, and position information thereof, in a correlated manner.

The recovery information DB 212 stores recovery information of infrastructure facilities of infrastructure businesses, received from the infrastructure businesses. Recovery information includes at least position information of facilities and scheduled date and time of recovery, in a correlated manner.

The map information DB 213 stores digital map information of all Japan. The publicized information DB 214 stores failure information and recovery information for publicizing, where detailed information of failure information and recovery information has been processed into simplified contents by a data analyzing unit 221 (described later).

The control unit 22 has internal memory for storing programs defining various types of processing procedures and so forth, and necessary data, and executes various types of processing thereby. The control unit 22 is an electronic circuit such as a CPU (Central Processing Unit) or MPU (Micro Processing Unit) or the like, for example. The control unit 22 has the data analyzing unit 221 (analyzing unit) and a concealed map display unit 222 (output unit).

The data analyzing unit 221 collects failure information of infrastructures and recovery information of infrastructures from the infrastructure businesses. The data analyzing unit 221 then analyzes the failure information of infrastructures and recovery information of infrastructures, and processes it into contents where detailed information of the failure information and recovery information has been simplified. In other words, the data analyzing unit 221 performs this processing so that others cannot identify failure positions and so forth, which are internally confidential for the businesses.

At the time of the above processing, the data analyzing unit 221 maps failure locations on a map based on the failure information of infrastructures, and assigns levels for failure levels at the failure locations. The data analyzing unit 221 then, for example, sections object districts into a grid, and creates first concealed information that is mesh data where failure levels corresponding to a range sectioned into a grid are displayed in this range. For example, the data analyzing unit 221 sections an object district into a grid in 1-km increments. Alternatively, the data analyzing unit 221 may create mesh data displaying level values of failure levels in the range sectioned into a grid, or graph images corresponding to level values, as the first concealed information.

The data analyzing unit 221 also maps recovery regions on the map on the basis of recovery information of infrastructures, and gives an order of priority to recovery plans in each recovery region. The data analyzing unit 221 creates second concealed information where the order of priority of recovery plans in an object district has been made into a heatmap display. Alternatively, the data analyzing unit 221 may map the date and time of recovery itself for infrastructures on the map instead of the order of priority of in the recovery plan for infrastructures, and thereafter process the date and time of recovery into an approximate date and time, as the second concealed information.

In a case of having received a request for failure information and recovery information, the concealed map display unit 222 outputs the failure information and recovery information that the data analyzing unit 221 has processed to the requester. The concealed map display unit 222 performs display output of failure map information, where the first concealed information (failure information) created by the data analyzing unit 221 is superimposed on the map information, to the requester. The concealed map display unit 222 also performs display output of recovery map information, where the second concealed information (recovery information) created by the data analyzing unit 221 is superimposed on the map information, to the requester.

[Flow of Processing]

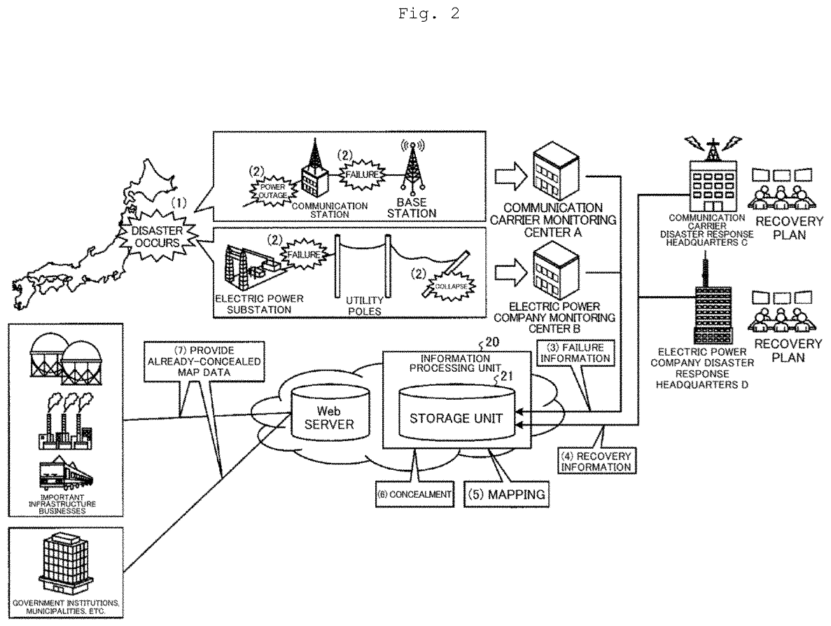

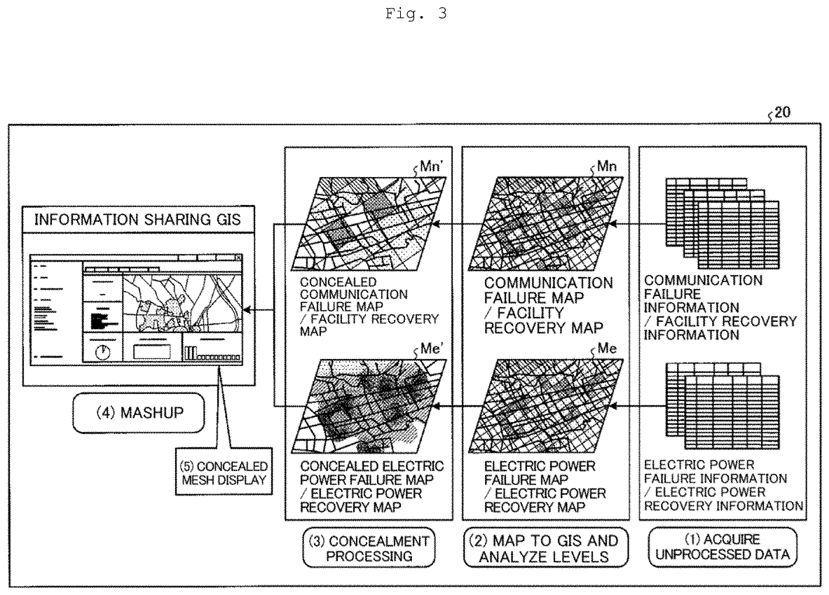

Next, the flow up to the information processing device 20 providing failure information and recovery information of the infrastructures to the infrastructure businesses, government institutions, municipalities, and so forth, will be described. FIG. 2 and FIG. 3 are diagrams for describing the flow of processing by the information processing device 20 illustrated in FIG. 1.

As illustrated in FIG. 2, a disaster occurs (see (1) in FIG. 2), causing failures at infrastructure facilities, such as power outage at communication stations, failure at base stations and electric power substations, collapse of utility poles, and so forth (see (2) in FIG. 2). A monitor center A of a communication carrier and a monitor center B of an electric power company detect failures at the infrastructure facilities, and transmit the failure information to the information processing device 20 (see (3) in FIG. 2). Thereafter, disaster response headquarters C at the communication carrier and disaster response headquarters D at the electric power company each create recovery plans, and transmit the created recovery plans to the information processing device 20 (see (4) in FIG. 2).

According to the above flow, the information processing device 20 can acquire failure information and recovery information of each of the infrastructures. The information processing device 20 then maps failure locations on the map on the basis of the acquired failure information of the infrastructures, and assigns levels to the failure locations (see (5) in FIG. 2). The information processing device 20 then maps recovery regions on the map on the basis of the acquired recovery information for the infrastructures, and gives order of priority for recovery plans in each recovery region (see (5) in FIG. 2).

Next, the information processing device 20 performs concealment processing of secret information contained in the post-analysis failure information and recovery information (see (6) in FIG. 2). Specifically, the information processing device 20 processes detailed information of the failure information and recovery information into simplified contents. Thus, the failure information and recovery information of the infrastructures is processed into contents that can be disclosed, and is provided to infrastructure businesses, government institutions, municipalities, and so forth, as already-concealed map data (failure map information, recovery map information) via a Web server (see (7) in FIG. 2).

The processing that the information processing device 20 performs will be described further with reference to FIG. 3. In the information processing device 20, the data analyzing unit 221 acquires unprocessed data of failure information and recovery information from the infrastructure businesses (see (1) in FIG. 3), as illustrated in FIG. 3. Unprocessed data is table data correlating identification information of facilities where failures have occurred, and position information thereof, for example. Unprocessed data is also table data correlating position information of facilities and scheduled date and time of recovery.

The data analyzing unit 221 then analyzes the unprocessed data, and generates map data where the detailed information of the failure information and recovery information have been processed into simplified contents, as illustrated in (2) in FIG. 3.

Specifically, the data analyzing unit 221 extracts position information of facilities where failures have occurred from the failure information, and performs mapping of the failure locations onto a map acquired from a geographic information system (GIS: Geographic Information System), on the basis of the position information. The data analyzing unit 221 then creates map data Mn where levels have been assigned for failure levels at the failure locations. The data analyzing unit 221 also extracts position information of recovery regions from the recovery information, and performs mapping of the recovery regions onto a map acquired from a GIS, on the basis of the position information. The data analyzing unit 221 then creates map data Me where order of priority has been given for recovery plans for each recovery region.

Next, the data analyzing unit 221 performs concealing processing, as illustrated in (3) in FIG. 3. Specifically, the data analyzing unit 221 creates map data Mn′ where failure levels have been made into mesh data. The data analyzing unit 221 also creates map data Me′ where the order of priority of recovery plans has been made into a heatmap display.

In a case of receiving a request for failure information and recovery information, the concealed map display unit 222 then makes a mashup of the map data Mn′ and Me′ on map data on the GIS (see (4) in FIG. 3), and performs display output to the requester infrastructure business or the like. The failure information or recovery information is displayed in a state where detailed information is simplified and secret information is concealed (e.g., a mesh display) at the requesting infrastructure business or the like (see (5) in FIG. 3). Note that the information processing device 20 separately selects necessary information, and provides to government institutions, municipalities, and so forth. Also, such failure information and recovery information is viewable among infrastructure businesses that have entered into an agreement.

[Processing by Data Analyzing Unit]

Next, processing by the data analyzing unit 221 will be described. First, mapping of failure information onto map data will be described. The data analyzing unit 221 connects by communication to monitoring centers of infrastructure businesses, collects failure information, and registers the collected failure information in the failure information DB 211. The data analyzing unit 221 receives recovery information from disaster response headquarters of infrastructure businesses and registers the received recovery information in the recovery information DB 212.

The data analyzing unit 221 then analyzes the failure information. First, the data analyzing unit 221 processes failure information in increments of district addresses into a 1-km mesh, and displays in colors according to density of failures. For example, a failure parameter is set as “f1{P(latitude and longitude), L(area)}”. Determination of the failure parameter density is performed according to f1 count (=1-km mesh).

In a case where f1>10, the data analyzing unit 221 determines that the degree regarding devastation probability and extent of damage is level 3. In a case of classifying the degree regarding devastation probability and extent of damage into three levels of great, moderate, and small, level 3 is a level where the devastation probability is great and the extent of damage is great.

In a case where f1=1 to 10, the data analyzing unit 221 determines that the degree regarding devastation probability and extent of damage is level 2. Level 2 is a level where the degree regarding devastation probability and extent of damage is moderate and the extent of damage is moderate.

In a case where f1<1, the data analyzing unit 221 determines that the degree regarding devastation probability and extent of damage is level 1. Level 1 is a level where the degree regarding devastation probability and extent of damage is moderate and the extent of damage is prize.

The data analyzing unit 221 then analyzes recovery information. Specifically, the data analyzing unit 221 obtains the order of priority of recovery plans. For example, a recovery parameter is set as “R1{L(area), T(scheduled date and time of recovery)}”.

In a case where R1<2 days, the data analyzing unit 221 determines that the recovery degree is level 3. In a case where the recovery degree is classified into three stages, level 3 is a level where immediate recovery is scheduled. In a case where R1=2 to 5 days, the data analyzing unit 221 determines that the recovery degree is level 2. Level 2 is a level where recovery is scheduled after several days. In a case where R1>null, the data analyzing unit 221 determines that the recovery degree is level 1. Level 1 is a level where no recovery plan is scheduled.

The data analyzing unit 221 then performs concealing processing where the detailed information of the failure information and recovery information have been processed into simplified contents, so that the infrastructure businesses can share information. For example, the data analyzing unit 221 colors each level for failure information with a different color, and makes into a mesh display in 1-km increments or 10-km increments. The data analyzing unit 221 colors each level for recovery information with a different color, and displays a heatmap on the GIS.

[Processing Procedures of Information Providing Processing]

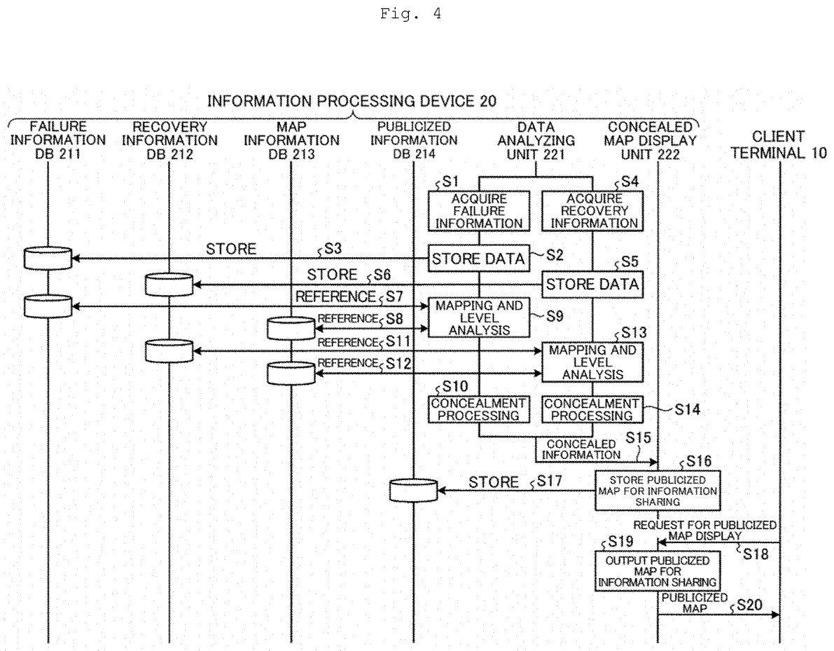

Next, processing procedures of information providing processing according to the embodiment will be described. FIG. 4 is a sequence diagram illustrating the processing procedures of information providing processing according to the embodiment.

As illustrated in FIG. 4, the data analyzing unit 221 first acquires failure information of infrastructures from the infrastructure businesses (step S1), and stores the acquired data in the failure information DB 211 (steps S2 and S3). Next, the data analyzing unit 221 acquires recovery information of infrastructures from the infrastructure businesses (step S4), and stores the acquired data in the recovery information DB 212 (steps S5 and S6).

Next, the data analyzing unit 221 refences the failure information DB 211 and the map information DB 213 (steps S7 and S8), maps failure locations on the map, and assigns levels for failure levels at the failure locations (step S9). The data analyzing unit 221 then performs concealing processing to make the failure levels into mesh data (S10), and processes detailed failure information into simplified contents.

Next, the data analyzing unit 221 refences the recovery information DB 212 and the map information DB 213 (steps S11 and S12), maps recovery regions on the map, and assigns levels for the order of priority of recovery plans for the recovery regions (step S13). The data analyzing unit 221 then performs concealing processing to make the order of priority of recovery plans into a heatmap display (S14), and processes detailed recovery information into simplified contents.

The data analyzing unit 221 outputs the already-concealment-processed information to the concealed map display unit 222 (step S15). The concealed map display unit 222 stores the already-concealed information (image data relating to failures or recovery) in the publicized information DB 214 as a publicized map for sharing information (steps S16 and S17).

Upon receiving a request for a publicized map from a client terminal 10 at an infrastructure business or the like (step S18), the concealed map display unit 222 creates a mashup of map data relating to the failure or recovery that has been requested on map data on the GIS, and performs display output to the requester infrastructure business or the like (steps S19 and S20).

### Advantages of the Embodiment

In this way, the information processing device 20 according to the embodiment analyzes failure information of infrastructures and recovery information of infrastructures, processes detailed information of the failure information and recovery information into simplified contents, and in a case of receiving a request for information and recovery information, outputs the processed failure information and recovery information to the requester, and enables information sharing among infrastructure businesses. Accordingly, in a case where important infrastructure businesses such as communication, power, or the like, have been affected by an earthquake or the like, the information processing device 20 can enable the infrastructure businesses to speedily implement their own facility recovery, by enabling the infrastructure businesses to share the state of damage and recovery information of their infrastructures with each other.

Thus, according to the present embodiment, social infrastructures can be speedily recovered by important infrastructure businesses sharing failure information or recovery information with each other. According to the present embodiment, the infrastructure businesses can effectively distribute their own resources by comprehending recovery information of other infrastructures, and can perform efficient recovery work. For example, by sharing an electric power recovery plan, a plan for distribution of fuel to base stations and so forth of a communication carrier can be formulated. Also, according to the present embodiment, information relating to failures and recovery can also be suitably appropriated to the national government, municipalities, and so forth, and accordingly can contribute to early recovery in various districts.

Also, the information processing device 20 processes detailed information of the failure information and recovery information, with regard to secret information such as contents of monitoring by monitoring devices, into simplified contents, and provides as information that can be publicized, thereby enabling prevention of leakage of secret information of the infrastructure businesses.

As described above, the present embodiment provides a cloud system that enables sharing among infrastructure businesses, by performing concealment processing where detailed information of the failure information of infrastructures and recovery information of infrastructures is processed into simplified contents. Thus, according to the present embodiment, cooperation regarding information can be suitably carried out among infrastructure businesses, thereby assisting in early recovery of the social infrastructure.

Note that in addition to analyzing failure information of infrastructures and recovery information of infrastructures, and creating map data having been made into the form of mesh data or a heatmap display as concealed information, the data analyzing unit 221 may create data where numerical values in table data themselves have been processed, as concealed information. In this case, the data analyzing unit 221 position shows together, in a single row, a plurality of pieces of failure information or recovery information that are close regarding position. The data analyzing unit 221 then may perform processing to simplify detailed numbers of failure sites and detailed recovery dates and times to an approximate number or an approximate date and time.

[System Configuration, Etc.]

The components of the devices illustrated in the Figures are functionally conceptual, and are not necessarily physically configured as illustrated in the Figures. That is to say, specific forms of dispersion/integration of the devices are not limited to those illustrated in the Figures, and all or part may be configured functionally or physically dispersed/integrated in optional increments in accordance with various types of loads, usage conditions, and so forth. Further, all or an optional part of the processing functions carried out at each device may be realized by a CPU and a program executed for analysis by the CPU, or alternatively may be realized as hardware through wired logic.

Also, of the processes described in the present embodiment, all or part of processes described as being automatically performed can be manually performed. Alternatively, all or part of processes described as being manually performed can be automatically performed by known methods. Moreover, processing procedures, control procedures, specific names, and information including various types of data and parameters, shown in the above document and Figures, can be optionally changed unless specifically stated otherwise.

[Program]

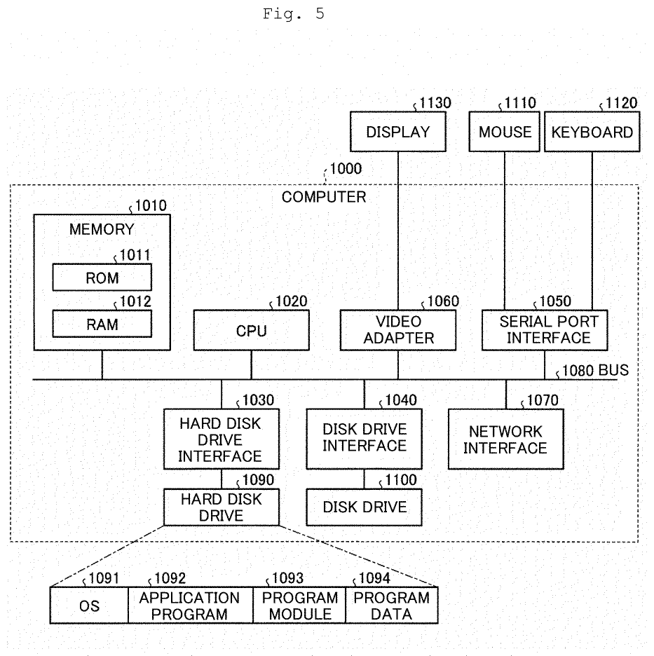

FIG. 5 is a diagram illustrating an example of a computer where the information processing device 20 is realized by a program being executed. A computer 1000 has memory 1010 and a CPU 1020, for example. The computer 1000 also has a hard disk drive interface 1030, a disk drive interface 1040, a serial port interface 1050, a video adapter 1060, and a network interface 1070. These parts are connected by a bus 1080.

The memory 1010 includes ROM (Read Only Memory) 1011 and RAM 1012. The ROM 1011 stores a boot program such as a BIOS (Basic Input Output System), for example. The hard disk drive interface 1030 is connected to a hard disk drive 1090. The disk drive interface 1040 is connected to a disk drive 1100. A detachable storage medium such as a magnetic disk or optical disc or the like, for example, is inserted to the disk drive 1100. The serial port interface 1050 is connected to, for example, a mouse 1110 and keyboard 1120. The video adapter 1060 is connected to a display 1130, for example.

The hard disk drive 1090 stores, for example, an OS (Operating System) 1091, an application program 1092, a program module 1093, and program data 1094. That is to say, a program that defines each processing of the information processing device 20 is implemented as a program module 1093 in which code that is executable by the computer is described. The program module 1093 is stored in the hard disk drive 1090, for example. A program module 1093 for executing the same processing as the functional configurations of the information processing device 20, for example, is stored in the hard disk drive 1090. Note that an SSD (Solid State Drive) may substitute for the hard disk drive 1090.

Also, settings data used in processing in the above-described embodiment is stored in the memory 1010 or hard disk drive 1090, for example, as the program data 1094. The CPU 1020 then reads the program module 1093 and program data 1094 stored in the memory 1010 or hard disk drive 1090 to the RAM 1012 as necessary, and performs execution thereof.

Note that the program module 1093 and program data 1094 is not limited to a case of being stored in the hard disk drive 1090, and may be stored in a detachable storage medium for example, and be read out by the CPU 1020 via the disk drive 1100 or the like. Alternatively, the program module 1093 and program data 1094 may be stored in another computer connected via a network (LAN, WAN, etc.). The program module 1093 and program data 1094 may then be read out from the other computer by the CPU 1020 via the network interface 1070.

An embodiment to which an invention made by the present inventor has been applied has been described above, but the present invention is not limited by the description and Figures making up a part of the disclosure of the present invention by way of the present embodiment. That is to say, other embodiments, examples, operational technology, and so forth, made by one skilled in the art or the like on the basis of the present embodiment, are all encompassed by the scope of the present invention.

### REFERENCE SIGNS LIST

1 Information sharing system
10, 10A, 10B Client terminal
20 Information processing device
21 Storage unit
22 Control unit
30 Network
211 Failure information database (DB)
212 Recovery information DB
213 Map information DB
214 Publicized information DB
221 Data analyzing unit
222 Concealed map display unit

1. An information processing device, comprising: an analyzing unit that analyzes failure information of an infrastructure and recovery information of the infrastructure, and processes detailed information of the failure information and the recovery information into simplified contents; and an output unit that, in a case of receiving a request for the failure information and the recovery information, outputs the processed failure information and recovery information to a requester.

2. The information processing device according to claim 1, wherein the analyzing unit maps failure locations on a map on the basis of failure information of the infrastructure, and assigns a level for a failure level of each failure location, and maps recovery regions on a map on the basis of recovery information of the infrastructure, and gives an order of priority for a recovery plan to each recovery region.

3. The information processing device according to claim 2, wherein the analyzing unit creates first concealed information that is mesh data where an object district is sectioned into a grid, and the failure level corresponding to a range sectioned into a grid is displayed in this range, creates second concealed information that has been made into a heatmap display of the order of priority for the recovery plan of the object district, and wherein the output unit performs display output of failure map information, where the first concealed information is superimposed on map information, to the requester, and performs display output of recovery map information, where the second concealed information is superimposed on map information, to the requester.

4. An information processing method executed by an information processing device, the method comprising: a step of analyzing failure information of an infrastructure and recovery information of the infrastructure, and processing detailed information of the failure information and the recovery information into simplified contents; and a step of outputting, in a case of receiving a request for the failure information and the recovery information, the processed failure information and recovery information to a requester.

5. An information processing program that causes a computer to execute a step of analyzing failure information of an infrastructure and recovery information of the infrastructure, and processing detailed information of the failure information and the recovery information into simplified contents, and a step of outputting, in a case of receiving a request for the failure information and the recovery information, the processed failure information and recovery information to a requester.
